(19) United States
(12) Patent Application Publication
(10) Pub. No.: US 2026/0367039 A1
(43) Pub. Date: Nov. 19, 2026

(54) Activatable Nanoprobes for Magnetic Particle Imaging

(71) Applicant: The Board of Trustees of the Leland Stanford Junior University, Stanford, CA (US)

(72) Inventors: Jianghong Rao, Palo Alto, CA (US); Zhen Xiao, Mountain View, CA (US)

(21) Appl. No.: 19/331,597

(22) Filed: Sep. 17, 2025

Related U.S. Application Data
(60) Provisional application No. 63/695,729, filed on Sep. 17, 2024.

(51) Int. Cl. G01N 27/72

(52) U.S. Cl. CPC G01N 27/72

(57) ABSTRACT

Activatable probes for magnetic particle imaging (MPI) are provided. These probes include a core that is a fused cluster of iron oxide nanocrystals, and a paramagnetic quencher bound to the surface of the core with a sensing species. We have found that such a quencher indeed reduces the MPI signal, but that the fused cluster configuration of the core is important for this quenching to occur. Therefore, by choosing a sensing species that is cleavable by a target molecule (often a biologically significant molecule), the MPI signal is made sensitive to the presence of the target molecule. Experiments to date have demonstrated the target molecule can be cell signaling molecules, reducing agents, and proteases. This idea is expected to be generally applicable to any cleavable sensing species chemistry.

### CROSS REFERENCE TO RELATED APPLICATIONS

This application claims priority from U.S. Provisional Patent Application 63/695,729 filed Sep. 17, 2024, which is incorporated herein by reference.

### GOVERNMENT SPONSORSHIP

None.

### FIELD OF THE INVENTION

This invention relates to magnetic particle imaging.

### BACKGROUND

Magnetic Particle Imaging (MPI) represents a cutting-edge imaging modality known for its exceptional spatial resolution and absence of background noise, setting it apart from conventional imaging techniques. By utilizing the unique non-linear magnetization response of superparamagnetic nanoparticles to an alternating magnetic field, MPI generates detailed images with outstanding clarity and contrast. The low excitation frequencies used in MPI enable the signal to penetrate tissues without attenuation, facilitating deep organ imaging with minimal interference. Notably, magnetic nanoparticles, particularly iron oxide formulations, have garnered approval from the FDA for clinical trials, underscoring their safety and potential clinical utility. With its capability for sensitive and real-time monitoring of diverse biological activities within living organisms, MPI holds promise for advancing clinical imaging practices. Despite these advantages, unlike activatable fluorescent probes and bioluminescent probes, developing activatable MPI tracers that selectively respond to specific biological targets, such as enzymes, remains a critical unmet need in the field.

### SUMMARY

Here, for the first time, we demonstrated a new nanoprobe as an MPI agent featuring activatable contrasts. The nanoprobe includes a superparamagnetic iron oxide nanocrystal cluster and a paramagnetic MPI quencher. The magnetic cluster exhibits superior magnetic properties and has excellent intrinsic MPI contrast with a detection limit of 10 ng Fe. The signal per mass iron of the magnetic cluster is more than twice that of commercially available Vivotrax®, the gold standard for MPI contrast agents. As the quencher is chemically conjugated to the surface of the iron oxide, due to magnetic interactions, the MPI signal of the nanoprobe is reduced by 62% (Turn-off). When the quencher is removed from the surface, the MPI signal can be effectively recovered to the original state (Turn-on). Based on the reversible quenching property, bio-cleavable linkers have been used to develop activatable MPI probes. In vitro and in vivo studies demonstrated that with the reducing agent, GSH (glutathione), rapidly cleaving the disulfide bond, the quencher was removed from the iron oxide surfaces, leading to a 100% increase in the MPI signals. With tunable contrast and excellent sensitivity, this strategy of reversible MPI quenching can offer new opportunities for molecular diagnostics and various image-guided biomedical applications.

The commercial applications of MPI are still in the early stages, but there is growing interest and potential in various fields. Some of the commercial applications of MPI include:
1. Medical Imaging: MPI has the potential to revolutionize medical imaging because of its high sensitivity and the ability to produce real-time images of targeted areas within the body. It could be used for tracking specific cells, monitoring drug delivery, or imaging vascular structures.
2. Nanoparticle Tracking: MPI can be used in research and industry to track and quantify the movement of magnetic nanoparticles. This application is valuable in drug development, environmental monitoring, and material science fields.
3. Theranostics: The combination of diagnostics and therapy, known as theranostics, is an emerging field where MPI could play a key role. By utilizing magnetic nanoparticles for both imaging and targeted drug delivery, MPI can potentially enhance personalized medicine approaches.
4. Preclinical Research: MPI is well-suited for preclinical imaging studies in research settings, providing researchers with a powerful tool for studying disease models, treatment efficacy, and biological processes at a molecular level.

With our MPI probe well-suited for molecular sensing, we can expect to see a broader range of commercial applications for MPI in the future.

Significant advantages are provided. MPI can detect trace concentrations of magnetic nanoparticles with high sensitivity and can provide quantitative data on the concentration and distribution of magnetic nanoparticles, which can be beneficial for tracking therapies or specific biological processes. MPI also offers real-time imaging, allowing for dynamic visualization of processes within the body, such as blood flow or drug delivery. Since MPI signals are not impacted by tissue properties, such as water content or fat, it can provide consistent image quality regardless of tissue type.

Our probes capability in molecular sensing for various biological targets can further boost MPI for various applications, particularly in the fields of molecular imaging, regenerative medicine, and targeted drug delivery.

### BRIEF DESCRIPTION OF THE DRAWINGS

FIGS. 1A-E show MPI characterization of magnetic nanocrystal clusters.

FIGS. 2A-I show characterization of the MPI quenching effect.

FIGS. 3A-D relate to the effect of the dispersion in a highly viscous medium on the MPI signals.

FIGS. 3E-H relate to distance-dependent MPI quenching. FIGS. 4A-F show an activatable MPI probe results for nitric oxide sensing.

FIGS. 5A-F show activatable MPI probe results for glutathione sensing.

FIGS. 6A-I show activatable MPI probe result for granzyme B sensing.

### DETAILED DESCRIPTION

### 1) Introduction

Magnetic Particle Imaging (MPI), a new imaging modality, utilizes superparamagnetic nanoparticles' unique non-linear magnetization response to an alternating magnetic field to map their location for non-invasive imaging. Because it employs relatively low excitation frequencies, MPI signals can penetrate deeply into tissues with negligible attenuation and nearly zero background interference. MPI has the potential to offer sensitive, real-time monitoring of various biological activities in vivo and could be translated for clinical imaging. In comparison to MRI (magnetic resonance imaging), MPI has much better sensitivity, and the current preclinical MPI scanner can detect a few μg to hundreds of ng Fe mass of the tracer. Highly anisotropic MPI tracers, including cubic and rod nanoparticles, have been synthesized and these may improve image quality. New superferromagnetic tracers are being optimized for extraordinary sensitivity and spatial resolution.

Many powerful strategies have been developed to modulate optical signals, affording activatable fluorescent and bioluminescent probes for imaging physiologically important biomolecules including ions (e.g., Ca²⁺, Cl⁻), small signaling molecules (e.g., nitric oxide [NO], cyclic adenosine monophosphate [CAMP] ), and enzymes (e. g., proteases and kinases). Similarly, activatable MRI probes have been developed by activity-dependent modulation of the relaxivity of the probes, for example, altering the water coordinate number to the paramagnetic metal, changing the size of the contrast agents, or introducing paramagnetic relaxation enhancement. In the case of positron emission tomography (PET), it is not feasible to modulate the radioactive decay, an intrinsic property of positron-emitting radionuclides. Given the attractive features offered by MPI for non-invasive, tomographic imaging with nearly zero tissue attenuation, extremely low background, linearity of signals versus tracer concentration, and high imaging sensitivity, activatable MPI probes could offer promise, especially in whole body scans, where scatter and attenuation severely limit optical imaging.

There have been very few examples of activatable MPI probes for molecular sensing and imaging. One study introduced an environmentally responsive MPI tracer that undergoes enzymatic degradation, gradually dissolving the Fe₃O₄ core (around 3 to 30 days) and causing a measurable decline in MPI signals. Another strategy was demonstrated to monitor drug release by encapsulating the drug with tightly packed (and hence quenched) 25 nm Fe₃O₄ magnetic nanoparticles that were dominated by Brownian motion. When the drug and nanoparticles were released simultaneously, the MPI signal was no longer quenched, and a measurable signal change shows regions of drug release. Here, we develop a novel strategy to modulate the signal of magnetic nanoclusters as new activatable MPI probes.

We first prepared iron oxide nanocrystal multicore clusters that exhibit superior magnetic properties and excellent intrinsic MPI sensitivity with a detection limit of 10 ng Fe on the Momentum MPI scanner. The signal per mass iron of the magnetic cluster is more than twice that of commercially available Vivotrax®, the gold standard for MPI tracer. We demonstrated that the magnetization response of the clusters is dominated by Neel relaxation. Attaching the paramagnetic gadolinium chelate to the surface of the iron oxide nanoclusters, the MPI signal of the nanoprobe is reduced by 62% (Quenched). Removing gadolinium from the surface effectively recovered the MPI signal to the initial state (Activated). Using target-responsive linkers to conjugate gadolinium chelates to the magnetic clusters, we developed a series of activatable MPI probes and successfully demonstrated them for specific imaging of NO, GSH (glutathione), and granzyme B activity. With tunable MPI signals and excellent sensitivity, this strategy of reversible MPI quenching can offer new opportunities for probing biological interactions in deep tissues of living organisms non-invasively.

### 2) Results

### 2.1) Iron Oxide Nanoclusters for MPI Tracers

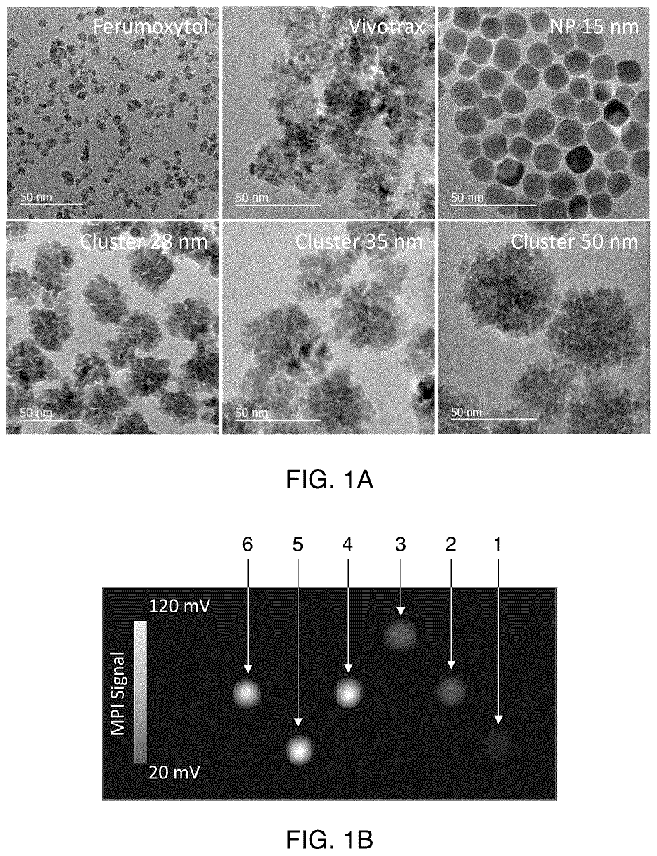

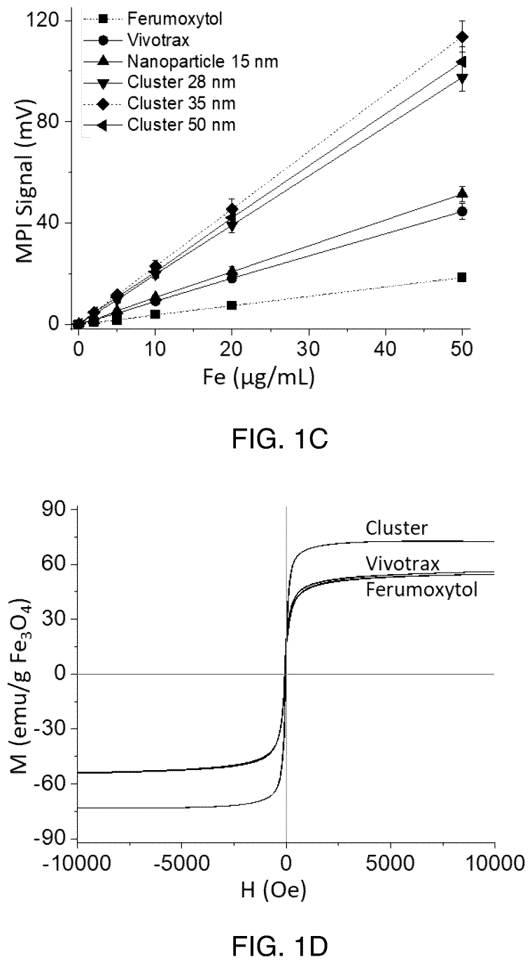

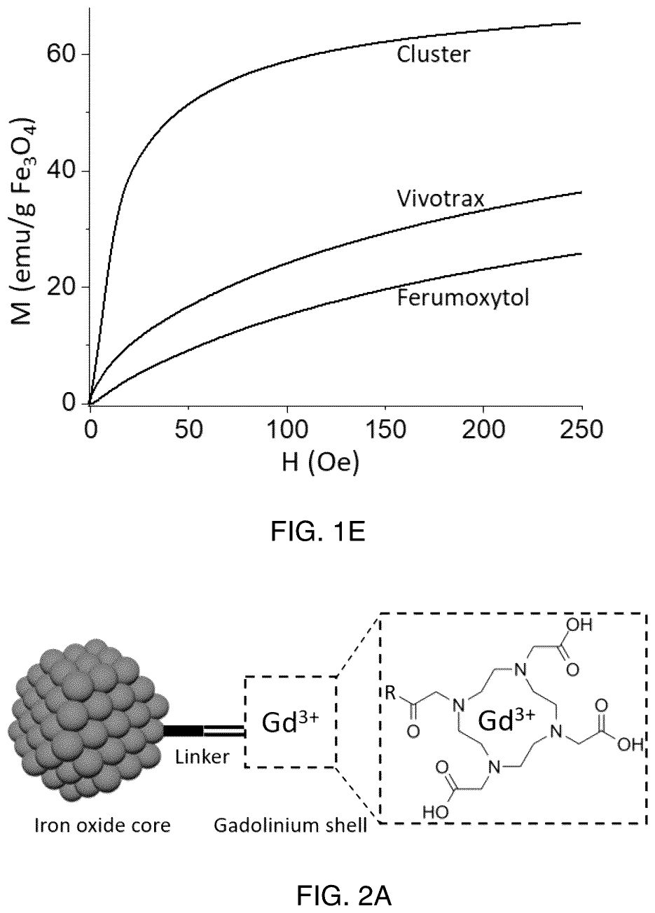

FIGS. 1A-E show MPI characterization of magnetic nanocrystal clusters. FIG. 1A shows the transmission electron microscopy (TEM) images of commercial Ferumoxytol, Vivotrax®, lab-synthesized 15 nm magnetic nanoparticles, and clusters (28 nm, 35 nm, and 50 nm, respectively).

FIG. 1B shows the MPI phantom images. These samples are numbered as: 1 Ferumoxytol, 2 Vivotrax®, 3 Nanoparticle 15 nm, 4-6 clusters 28 nm, 35 nm, and 50 nm. The volume for each sample is 100 μL, and the concentration is 50 μg/mL Fe. FIG. 1C shows the MPI signals of magnetic nanoparticles at different concentrations. FIGS. 1D-E show the magnetization curves of Ferumoxytol, Vivotrax®, and the 35 nm cluster at different field strengths.

We prepared single-core iron oxide nanoparticles (15 nm) and multicore nanocrystal clusters (28 nm, 35 nm, and 50 nm). Their morphologies were characterized by transmission electron microscopy (TEM) and shown in FIG. 1A. The 15 nm nanoparticles sample is composed of individual nanocrystals that are separated from others; in contrast, the clusters are uniform aggregates of several tens to hundreds of 4 nm nanocrystals partially merged at the interface during hydrothermal synthesis. The magnetic interactions among these nanocrystals can improve the clusters' responses to the external fields, therefore leading to superior magnetic properties. We compared these nanoclusters to two commonly used MPI tracers, Ferumoxytol and Vivotrax®. As measured by Magnetic Insight Momentum MPI scanner (20 mT and 45 kHz), at the same iron concentration of 50 μg/mL, the clusters exhibited the highest signals (FIG. 1B). Their MPI signals showed linear dependence on the iron concentration in the tested concentration range (FIG. 1C). For the single-core 15 nm nanoparticles, their MPI signal was much lower than that of all three nanocrystal clusters, but comparable to that of Vivotrax® and more than twice of Ferumoxytol (FIG. 1C). Our findings also revealed that the clusters demonstrated a limit of detection (LoD) of approximately 10 ng Fe and achieved a spatial resolution close to 1 mm. Further, we performed pulsed relaxometry measurements using the arbitrary waveform relaxometer (AWR) (40 mT and 20 kHz). The point-spread function (PSF) curve of the clusters has a full width at half maximum (FWHM) value of 4.6 mT, translating into a theoretical resolution of 0.79 mm at a gradient strength of 5.7 T/m in the Momentum MPI scanner. This performance surpasses that of Vivotrax®, which has a LoD of 25 ng Fe, FWHM of 12 mT, and a spatial resolution of around 2 mm, highlighting the clusters' enhanced sensitivity and clarity in imaging capabilities for MPI.

To examine their magnetic properties, the magnetization of these magnetic nanomaterials was measured (FIGS. 1D-E), and they all demonstrated superparamagnetism with nearly zero coercivity and remanence. The saturation magnetization of Ferumoxytol and Vivotrax® was around 56 emu/g, and 73 emu/g for the 35 nm clusters, as compared to 92 emu/g of the bulk Fe₃O₄. At a small field, the differences in the magnetic behaviors between these materials became more significant (FIG. 1E), in which the 35 nm clusters gave a much larger response to the field than Ferumoxytol and Vivotrax®, consistent with the trend of their MPI signals.

### 2.2) Exploring Mpi Quenching Using Gd Chelate

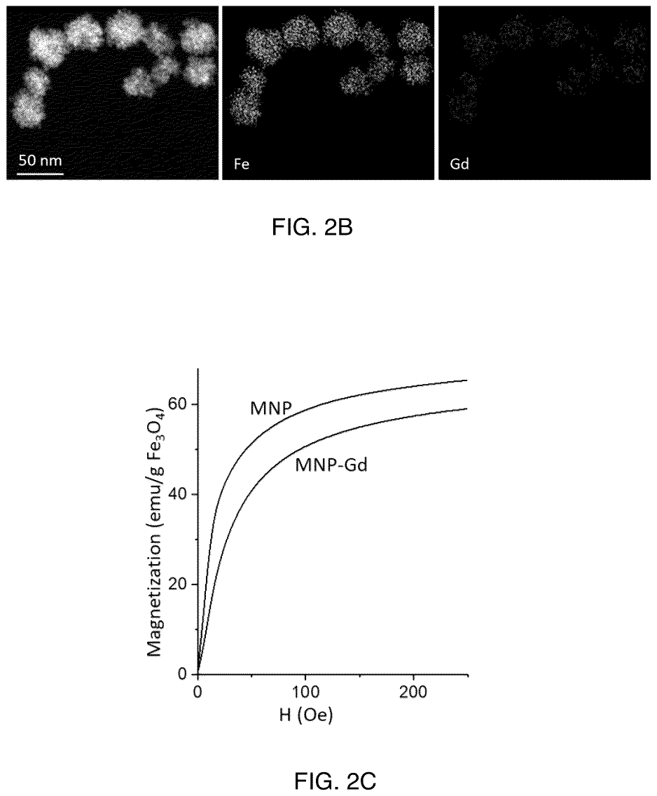

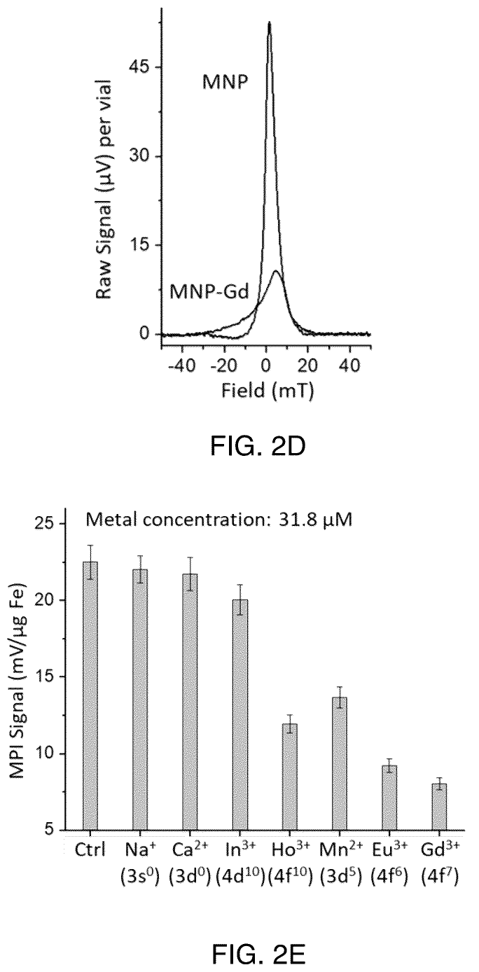

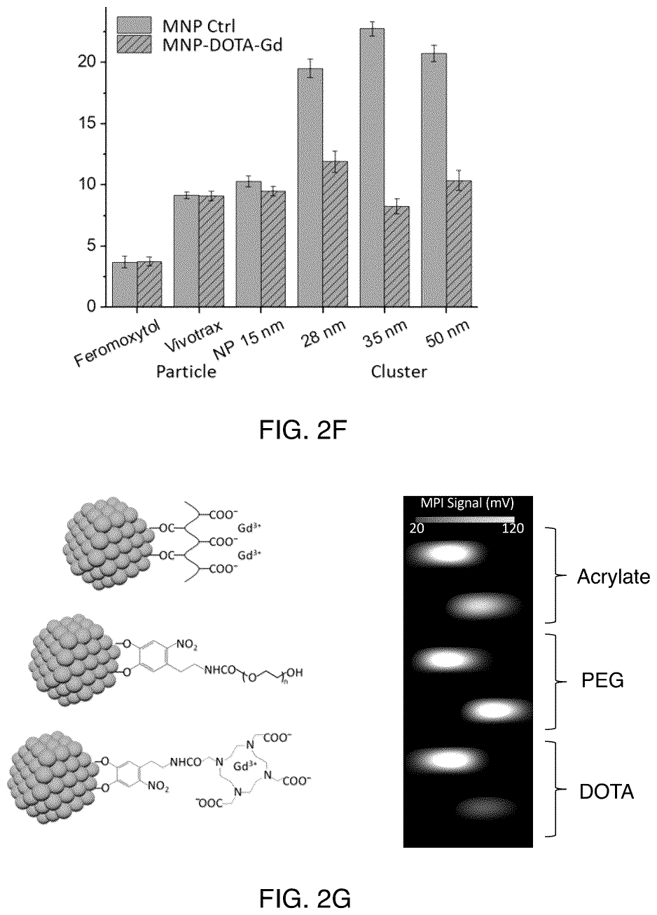

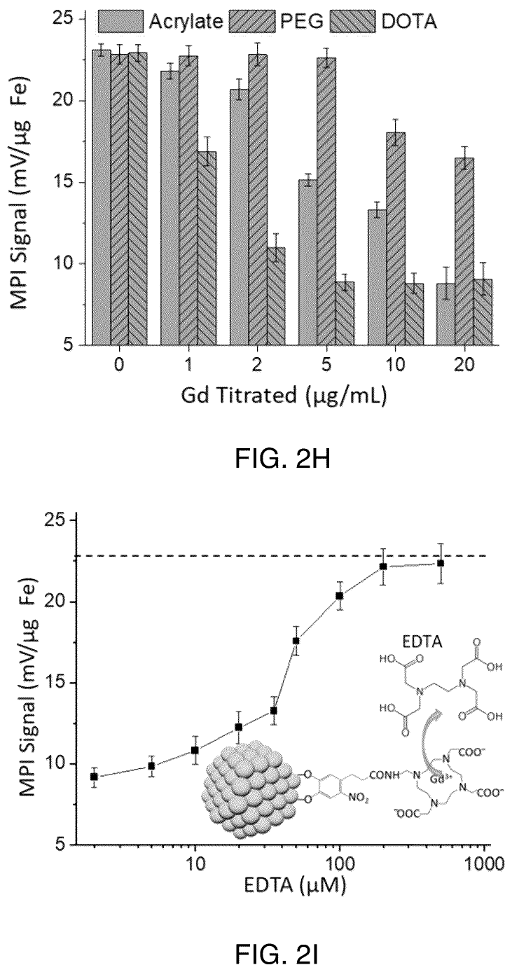

FIGS. 2A-I show characterization of the MPI quenching effect. FIG. 2A shows the construction of the activatable MPI probe. A layer of Gd3+on the MNP (magnetic nanoparticle) surface is achieved by conjugating a DOTA (dodecane tetraacetic acid) chelator with a linker that forms strong binding with the iron oxide core. FIG. 2B shows elemental mapping of Fe and Gd for the cluster-gadolinium nanocomplexes. FIGS. 2C-D show the magnetization curves, the MPI signals, and the point spread function (PSF) of the 35 nm cluster and the cluster-Gd nanocomplexes. FIG. 2E shows the quenching effect of various non-paramagnetic and paramagnetic metal ions on the DOTA-coated 35 nm cluster (50 μg/mL Fe). The concentration of these metals was kept at 31.8 μM. FIG. 2F shows comparison of Gd quenching on the magnetic nanoparticles (15 nm particles, Ferumoxytol, Vivotrax®) and clusters (28 nm, 35 nm, 50 nm). FIG. 2G is an illustration of the clusters interacting with Gd with the original acrylate, PEG (polyethylene glycol), and DOTA coatings and their respective MPI phantom images. The concentration of the MNP is kept at 50 μg/mL, and Gd³⁺ is 5 μg/mL. FIG. 2H shows the MPI signals of MNPs with indicated coatings at different Gd concentrations. FIG. 2I show that depriving Gd from the clusters' surface using EDTA (Ethylenediaminetetraacetic acid) can reverse the quenching effect and restore MPI signals.

Next, we explored the use of paramagnetic gadolinium to suppress the MPI signal of nanocrystal clusters to develop an activatable MPI probe. We speculate that with a layer of paramagnetic gadolinium, their spins can be coupled with the canted spins on the surface of magnetic clusters, therefore increasing the density of the randomly aligned spins against the core and decreasing the magnetic responses to the external field. We conjugated gadolinium-DOTA to the 35 nm clusters (FIG. 2A). The as-synthesized acrylate surface of the clusters was complexed with nitro-dopamine that was conjugated with dodecane tetraacetic acid (DOTA). The DOTA-coated nanoclusters were mixed with excessive GdCl₃ and magnetically washed three times to remove the free Gd³⁺. High-angle annular dark-field scanning transmission electron microscopy (HAADF-STEM), coupled with energy-dispersive X-ray spectroscopy (EDX), verified the MPI probe's structure as shown in FIG. 2B. Further, inductively coupled plasma optical emission spectroscopy (ICP-OES) revealed that the relative mass ratio of Fe to Gd was about 10:1.

MPI scanning was then performed on this cluster-gadolinium complex, which revealed that its MPI signals significantly decreased at the same Fe concentration compared to the clusters without Gd3+(FIG. 2C): inclusion of Gd³⁺ on the clusters can result in around 62% loss in the MPI signal. Magnetization measurements indicate that Gd³⁺ can lower the magnetization of the nanocomplex at smaller fields (FIG. 2D), which was consistent with a previous study of labeling superparamagnetic iron oxide with gadolinium chelates. Pulsed relaxometry measurements using AWR (Arbitrary Waveform Relaxometry) on the 35 nm clusters before and after Gd³⁺ complexation, as shown in FIG. 2E. The point spread function (PSF) curves indicated that Gd³⁺ conjugation can quench the raw signals and also impact the resolution by limiting the FWHM value of the curve, from 6.2 mT to 26 mT.

The effects of other metal cations on the MPI probe were also explored (FIG. 2E). Non-paramagnetic metals, including Nat, Ca²⁺, and In3+at a molar concentration (31.8 μM) equivalent to Gd³⁺ (5 Mg/mL vs. Fe of 50 Mg/ML), could not induce a significant MPI signal loss of the clusters. A slight decrease of the MPI signal by 17% when Ca²⁺ increased to 1000 μg/mL, which was likely due to the aggregation of clusters induced by a high concentration of the divalent Ca²⁺: the intra-cluster magnetic dipolar interactions reduced the magnetic susceptibility. On the contrary, other paramagnetic cations, such as Ho³⁺, Mn²⁺, and Eu³⁺, with free electrons on the d or f orbits, could effectively suppress the MPI signals.

We further confirmed that the quenching of MPI could only be achieved with Gd³⁺ on the surface, not in the solution. Clusters with different surface coatings were compared: polyacrylate-functionalized clusters (as-synthesized), polyethylene glycol (PEG)-functionalized clusters, and DOTA-functionalized clusters (FIG. 2G). After mixing them with GdCl₃, MPI scanning of the clusters showed that the DOTA coating showed the most efficient MPI quenching, followed by the polyacrylate functionalized cluster (FIG. 2H). On the contrary, the MPI signals of the PEG-functionalized clusters did not respond to Gd³⁺. This trend is consistent with the affinity of the surface coating for Gd³⁺. For the DOTA-coated nanoclusters, when EDTA, a non-specific metal chelator, was added to compete for Gd³⁺ with the DOTA on the cluster surfaces, the MPI signal recovered (FIG. 2I). The molar concentration of Gd-DOTA in the MPI probe was approximately 32 μM. Increasing the EDTA concentration to 200 μM fully restored the MPI signal to its original level. These results underscore the importance of the distance of Gd³⁺ to the nanocrystals for the MPI quenching effect.

The effect of Gd³⁺ on the other magnetic nanoparticles tested above was also explored (FIG. 2F). Each nanoparticles was first modified with Dopa-DOTA before being complexed with Gd³⁺. Compared to the minimal MPI signal changes observed in Gd³⁺-labeled Ferumoxytol, Vivotrax®, and the 15 nm lab-synthesized nanoparticles, the 28 nm and 50 nm clusters exhibited more pronounced quenching, while the 35 nm cluster displayed the highest quenching effect. Further AWR measurements revealed negligible PSF curve changes in these non-cluster materials. Taken together, these findings confirmed that the 35 nm cluster was the most suitable candidate for the activatable MPI probe.

### 2.3) Néel Relaxation Modulation

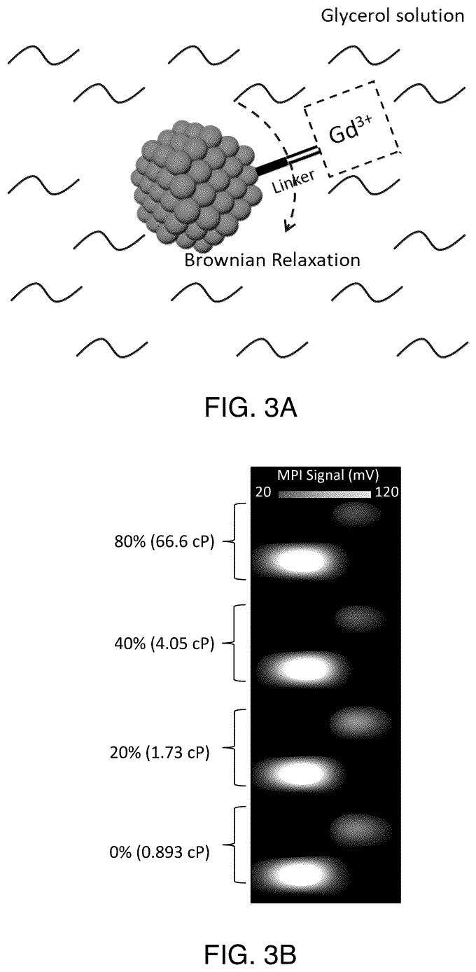

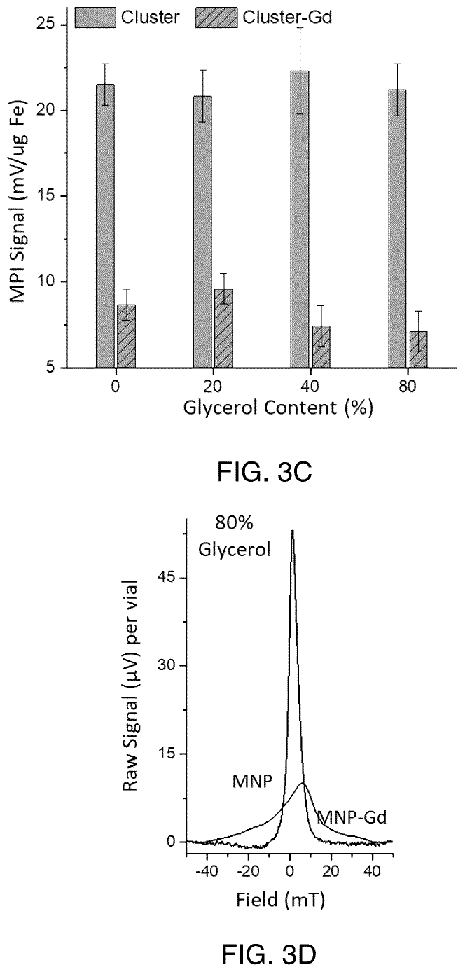

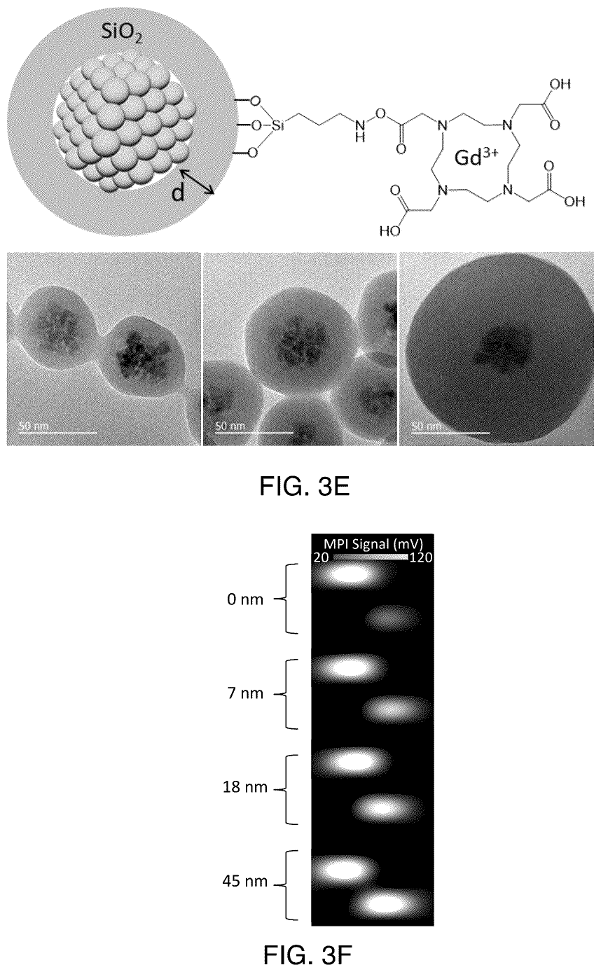

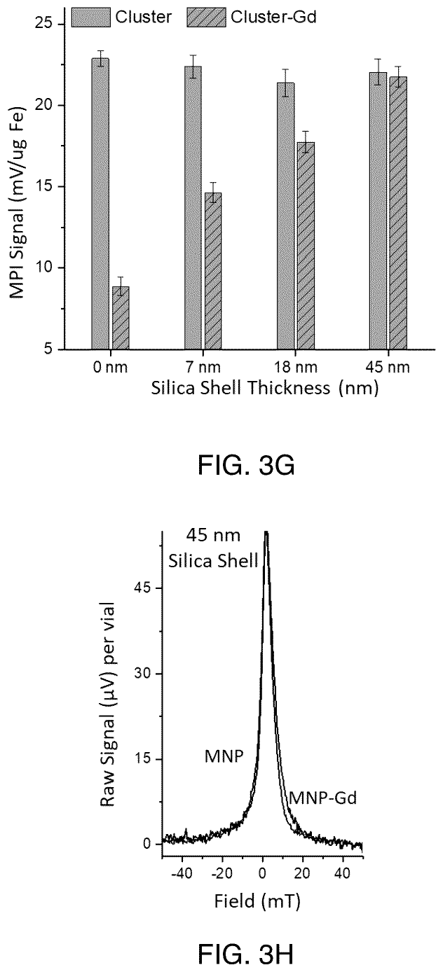

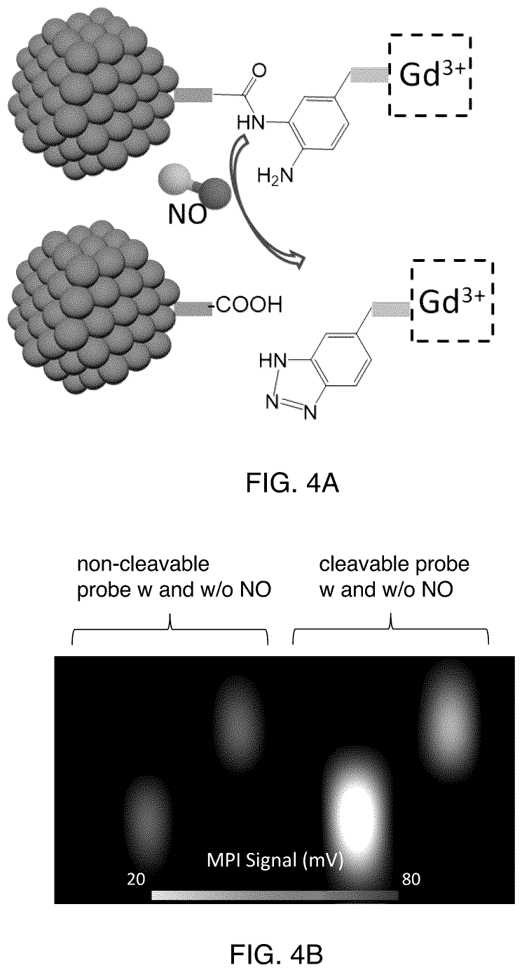

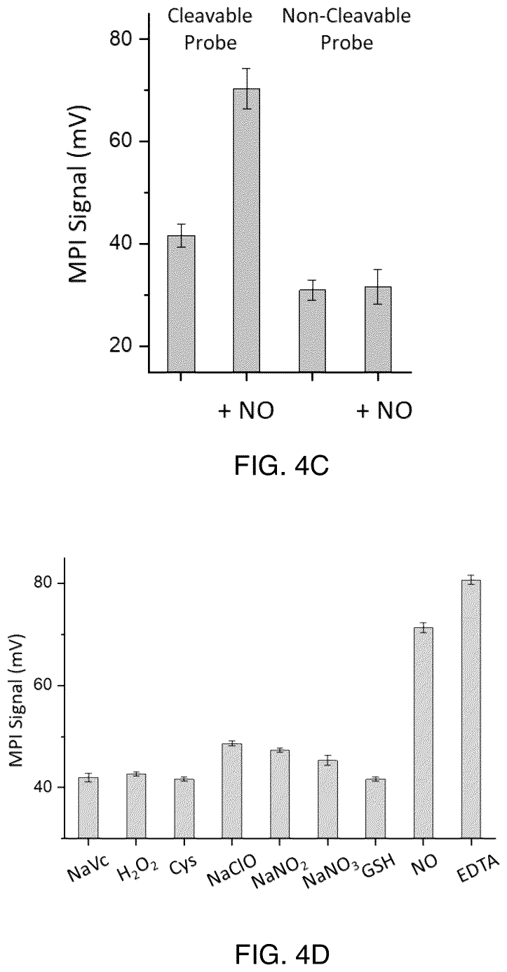

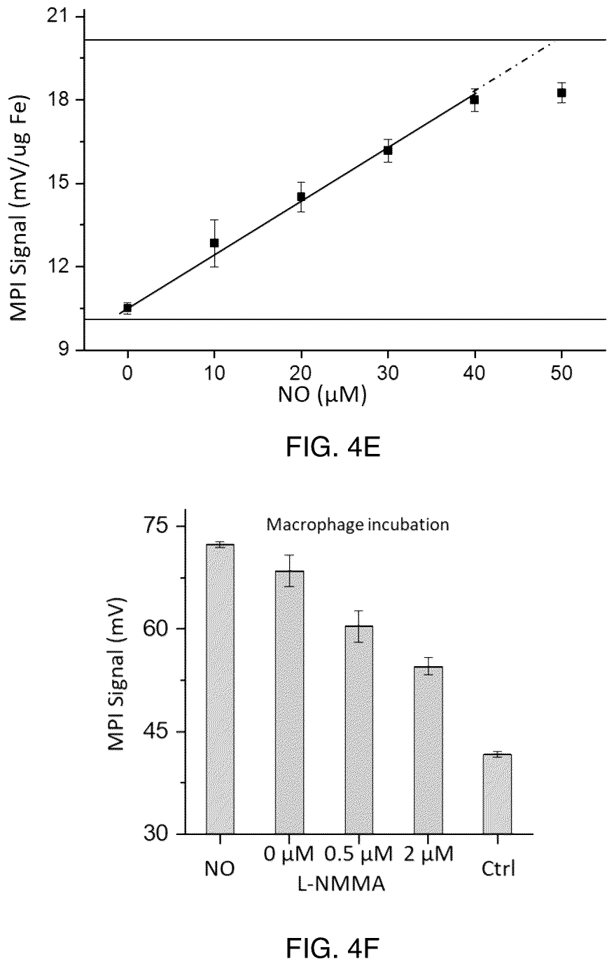

FIGS. 3A-D relate to the effect of the dispersion in a highly viscous medium on the MPI signals of the 35 nm cluster and clusters-Gd nanocomplex. FIGS. 3E-H relate to distance-dependent MPI quenching. FIG. 3A is a schematic of the Brownian relaxation of the clusters in the viscous glycerol solution. FIG. 3B shows the MPI phantom images of the clusters and clusters-Gd in water, 20% glycerol, 40% glycerol, and 80% glycerol, and the viscosity of the medium is 0.893 cP, 1.73 cp, 4.05 cP, and 66.6 cp, respectively.
FIG. 3C shows the MPI signal of the clusters and clusters-Gd in different media. FIG. 3D shows the PSF of the clusters and clusters-Gd in 80% glycerol with a FWHM of 5.8 mT and 25 mT, respectively. FIG. 3E shows a layer of silica shell with a thickness of 7 nm, 18 nm, and 45 nm was deposited onto the MNP surface and further conjugated with APTES-DOTA (top part is a schematic, the bottom part is corresponding images). FIG. 3F shows the MPI phantom images of the clusters with silica coatings and further Gd conjugations. FIG. 3G shows the MPI signal of the silica-coated clusters and clusters-Gd nanocomplex. FIG. 3H shows the PSF of the silica-coated clusters with a shell thickness of 45 nm and that conjugated with Gd³⁺, with a FWHM of 4.9 mT and 6.6 mT, respectively.

We next sought to investigate the mechanism underlying the quenching effect of Gd³⁺. A previous study proposed an activatable MPI probe by modulating the Brownian motion of the nanoparticles, which depends on the viscosity of the dispersion medium as well as the hydrodynamic size of the nanoparticles. We first examined the MPI signals of the 35 nm clusters in a mixture of water and glycerol with varying ratios (FIG. 3A). Even in the highly viscous glycerol solution, which can significantly limit the Brownian motion of the nanoparticles, the MPI signals of the 35 nm clusters changed little (FIGS. 3B-C), suggesting that the 35 nm clusters were not dominated by Brownian relaxation.

Additionally, AWR measurement of these samples in 80% glycerol showed that the PSF curves were consistent with those in water, with a similar peak intensity and FWHM values (FIG. 3D).

A non-magnetic silica layer was subsequently deposited on the surface of the clusters, with shell thicknesses of 7 nm, 18 nm, or 45 nm. This deposition resulted in a significant increase in both the overall physical diameters and the hydrodynamic sizes of the clusters, as confirmed by TEM and dynamic light scattering (DLS) analyses (FIG. 3E). Despite these changes in size, the MPI signals of the clusters, normalized by Fe mass, remained consistent across different silica shell thicknesses. Since the Brownian relaxation time is directly proportional to the hydrodynamic volume of the nanoparticles, the unchanged MPI signals and the consistent PSF curve shapes suggest that Brownian relaxation is not the primary contributor to the MNP signal (FIGS. 3F-G). Instead, it appears that Néel relaxation is influenced by the presence of Gd³⁺ on the cluster surfaces. The nearly identical PSF curves observed in both silica-coated and non-silica-coated clusters further support this conclusion.

We then investigated how the silica separation between the MNP core and the Gd³⁺ shell affects the MPI signal. The surface of the silica layer was modified with (3-Aminopropyl) triethoxysilane (APTES) to enable conjugation with DOTA. The presence of silica coatings significantly influenced the quenching effect of Gd³⁺ on the MPI signals. In the absence of silica coating, Gd³⁺ was able to quench 62% of the original MPI signal of 35 nm clusters.

However, with a layer of silica shells of 7 nm and 18 nm in thickness, the quenching effect was reduced to 35% and 17%, respectively. Remarkably, there was no MPI signal quenching in the clusters with the 45 nm thick silica shell. AWR measurements further demonstrated minimal differences after conjugating Gd³⁺ on the surface of the 45 nm silica-coated clusters, with both curves closely resembling those of the non-silica-coated clusters (FIG. 3H). This distance-dependent quenching by Gd³⁺ supports our hypothesis that the paramagnetic Gd³⁺ is magnetically coupled with the canted surface spins of the clusters, an interaction effective primarily within several nanometers.

### 2.4) Nitric Oxide Sensing Probe

FIGS. 4A-F show MPI probe for nitric oxide sensing. FIG. 4A is a schematic for the NO-responsive MPI probe. FIG. 4B shows phantom images of the NO-cleavable probe and non-cleavable probe interacting with NO. The concentration of the MPI probe was 50 μg/mL Fe. FIG. 4C is a comparison of the MPI signals of the NO-cleavable probe and non-cleavable probe with or without NO treatment. FIG. 4D shows the selectivity of the NO-cleavable probe. The concentration of sodium ascorbate (NaVc), hydrogen peroxide (H₂O₂), cysteine (Cys), sodium hypochlorite (NaClO), sodium nitrite (NaNO₂), sodium nitrate (NaNO₃), glutathione (GSH), and EDTA is 500 μM. The concentration of NO is 50 μM.

FIG. 4E shows the MPI signals of the NO-cleavable probe treated with different concentrations of NO. FIG. 4F shows the MPI signals of the macrophages treated with different concentrations of L-NMMA.

Nitric oxide (NO) is an important biological messenger that plays a crucial role in the immune response. Tumor-associated macrophages characteristically produce NO from an immunosuppressive (M2) phenotype toward an immunostimulatory (M1) phenotype as they metabolize arginine through the inducible nitric oxide synthase pathway. As NO is a marker of M1 macrophages' proinflammatory, pathogen-or tumor-killing response, imaging NO helps determine how effectively the treatment is prompting macrophage repolarization in the tumor microenvironment, thereby offering insight into treatment outcomes and prognosis. Optical NO probes, both fluorescence-and chemiluminescence-based probes, have been developed for NO imaging. Here, we demonstrate that the Gd³⁺ quenching strategy can be applied to develop an activatable MPI probe to detect NO involved in macrophage polarization. An NO-cleavable probe was developed using an o-phenylenediamine linker to bridge dopamine and DOTA (FIG. 4A). Upon reaction with NO, the o-phenylenediamine linker is cleaved to form a triazole, resulting in the detachment of DOTA-Gd from the nanoparticle surface.

Freshly prepared NO gas effectively increased the MPI signal of the NO-cleavable probe by 69% (FIGS. 4B-C), while producing minimal changes in the MPI signals of the non-cleavable probe. Although NO is a free radical with an unpaired electron, it does not affect the as-synthesized clusters with PAA (polyacrylic acid) coatings. The probe's selectivity was confirmed by treating it with various oxidizing or reducing agents at 500 μM, which resulted in negligible changes in the MPI signals. In contrast, a 50 μM NO stock solution robustly reactivated the MPI signal, yielding an intensity comparable to that induced by 500 μM EDTA. The MPI signals correlated linearly with NO concentration (0 to 40 μM) in PBS, highlighting its potential for quantitative NO sensing.

Lipopolysaccharide (LPS) and interferon-gamma (IFN-Y) were used to induce RAW 264.7 cells to adopt the M1 macrophage phenotype. When these M1 macrophages were exposed to the NO-cleavable probe for 6 hours, the MPI signal significantly increased, reaching levels comparable to treatment with a 50 μM NO stock solution. Additionally, inhibiting NO synthase within the cells using tilarginine acetate (L-NMMA) led to a dose-dependent reduction in the MPI signal (FIG. 4F). These findings demonstrate the specificity and effectiveness of the MPI probe for NO sensing in living cells.

### 2.5) MPI Sensing of Glutathione

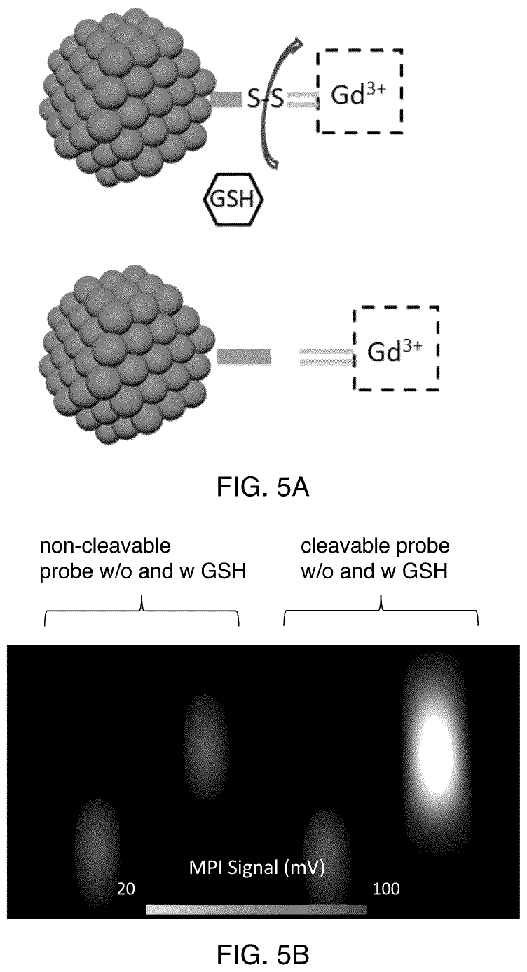

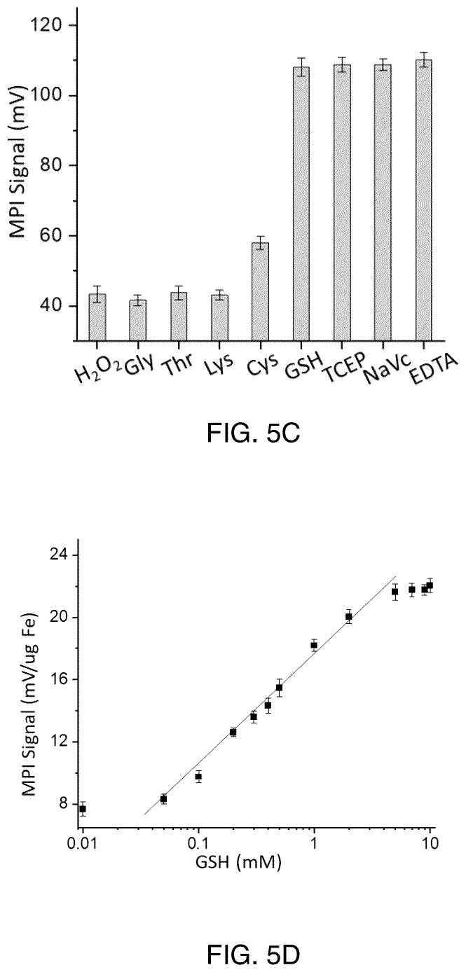

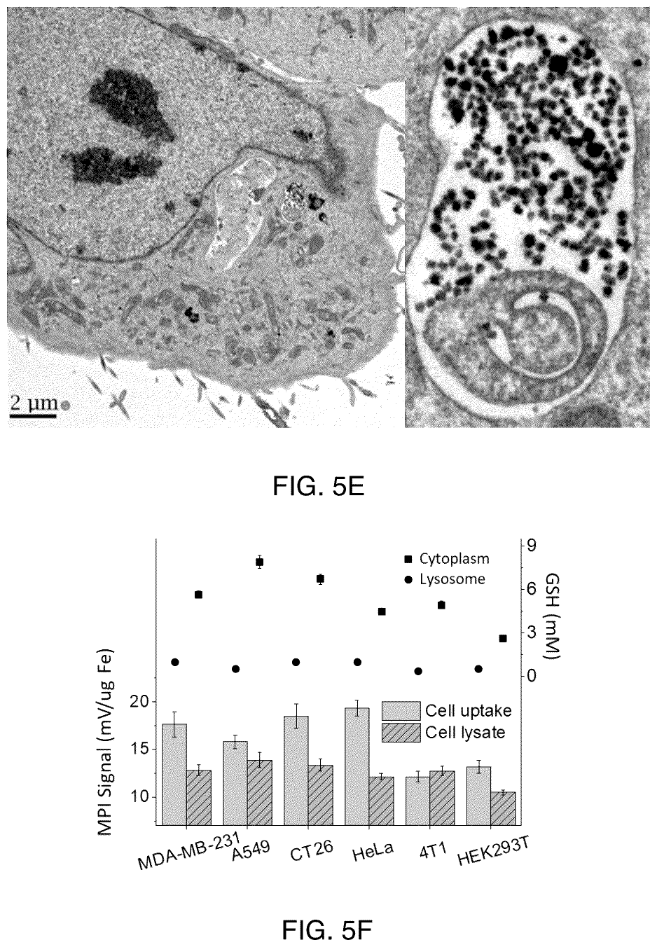

FIGS. 5A-F show GSH sensing probe results. FIG. 5A is a schematic for the GSH-responsive MPI probe. FIG. 5B shows phantom images illustrating that GSH could effectively turn on the MPI signal of the cleavable probe, while the non-cleavable probe remained unchanged. The concentration of the MPI probe was 50 μg/mL Fe. FIG. 5C shows the selectivity of the GSH sensing probe. The concentration of hydrogen peroxide (H₂O₂), glycine (Gly), cysteine (Cys), threonine (Thr), lysine (Lys), cysteine (Cys), glutathione (GSH), tris (2-carboxyethyl) phosphine (TCEP), sodium ascorbate (NaVc), and EDTA was 10 mM. FIG. 5D is a calibration curve of the MPI signals of the cleavable probe at different GSH concentrations with an incubation time of 2 h. FIG. 5E shows TEM images of MDA-MB-231 treated with the cleavable MPI probe at a concentration of 20 g/mL Fe. FIG. 5F shows the MPI signal of the probe after cellular uptake or direct treatment using cell lysis with different cell lines and the calculated GSH concentration in the lysosome (cell uptake) and cytoplasm (cell lysate treatment). For the in vitro studies, the incubation time was 2 h.

Glutathione (GSH) is the most abundant nonprotein thiol in living organisms and is essential for controlling cellular redox homeostasis due to its ability to scavenge reactive oxygen and nitrogen species. More importantly, an increased GSH level in tumor cells is often associated with increased resistance to chemotherapeutic drugs. Here we demonstrate the MPI quenching strategy for developing an activatable MPI probe for quantifying GSH levels in live cells. A GSH sensing probe was prepared by conjugating dopamine (dopa) and DOTA with a disulfide bridge (cluster-Dopa-S-S-DOTA-Gd), as shown in FIG. 5A. The cleavage of the disulfide linker by GSH removes Gd-DOTA from the clusters' surface and restores the MPI signal. The cleavage of the linker on the clusters' surface was independently verified by DLS, which shows the hydrodynamic size decreased by about 7 nm after GSH treatment. After incubating the probe (50 μg/mL Fe) with GSH (5 MM) for two hours, there was a 1.3-fold increase in the MPI signal (FIG. 5B). As a control, the non-cleavable probe (cluster-Dopa-DOTA-Gd) did not respond to the addition of GSH, confirming the specificity of the response to the GSH reduction.

We next evaluated the GSH-sensitive probe's selectivity against common oxidizing/reducing agents and other intracellular nucleophiles. The probe remained unresponsive to hydrogen peroxide and various amino acids (FIG. 5C). In contrast, it reacted strongly with reducing agents including GSH, tris (2-carboxyethyl) phosphine (TCEP), and sodium ascorbate (NaVc), producing an MPI signal similar to that observed with EDTA. Over GSH concentrations ranging from 50 μM to 5 mM, the MPI signal of the probe increased proportionally to the logarithm of GSH concentration after two hours of incubation (FIG. 5D). This result aligns with mass spectrometry data that directly monitored the reaction between the linker molecule and GSH. The biocompatibility of the MPI probe was assessed by incubating different cell lines with the clusters and the cluster-Gd complex. The bare iron oxide clusters showed negligible cytotoxicity toward all the cell lines used, with cell viability larger than 95% at a concentration of up to 200 μg/mL Fe. Although the inclusion of DOTA-Gd on the clusters induced more cell death at higher concentrations, the cluster-Gd complex is generally non-toxic when the iron concentration is less than 50 g/mL, corresponding to a Gd molar concentration of 32 μM.

In vitro studies were conducted where different cell lines were treated with the cleavable probe at a concentration of 10 μg/mL Fe for 2 hours (FIG. 5E). TEM images of the cells indicate the clusters accumulated in the lysosomes (FIG. 5F) after endocytosis. The cells were collected and measured on the MPI scanner, and then the iron content was determined by ICP, revealing a Fe level of several picograms per cell. The MPI signals of the probe after treatment were acquired. The increased MPI signals suggests the presence of GSH; however, the GSH concentrations in different cell lines were calculated by comparing the MPI signal with the calibration curve in FIG. 5D, which were found to be generally below 1 mM, indicating a lower GSH level in the lysosomes. The probe (10 μg/mL Fe) was also treated with cell lysates (10⁶ cells per test) for 2 hours, where the intact cells were subjected to ultrasonic lysis to facilitate GSH release from the cytoplasm. The lower MPI signals were due to the mixing of the extracellular solution and the dilution of GSH, considering the extremely small volume of the cells.

After conversion, the GSH concentration in the cytoplasm was in the range of 3 to 8 mM. The highest GSH level (7.9 mM) was found in A549 cells (lung carcinoma), consistent with previous studies. These results demonstrate the specificity and ability of the activatable MPI probe for sensing glutathione in living cells.

### 2.6) MPI of Granzyme B Activity

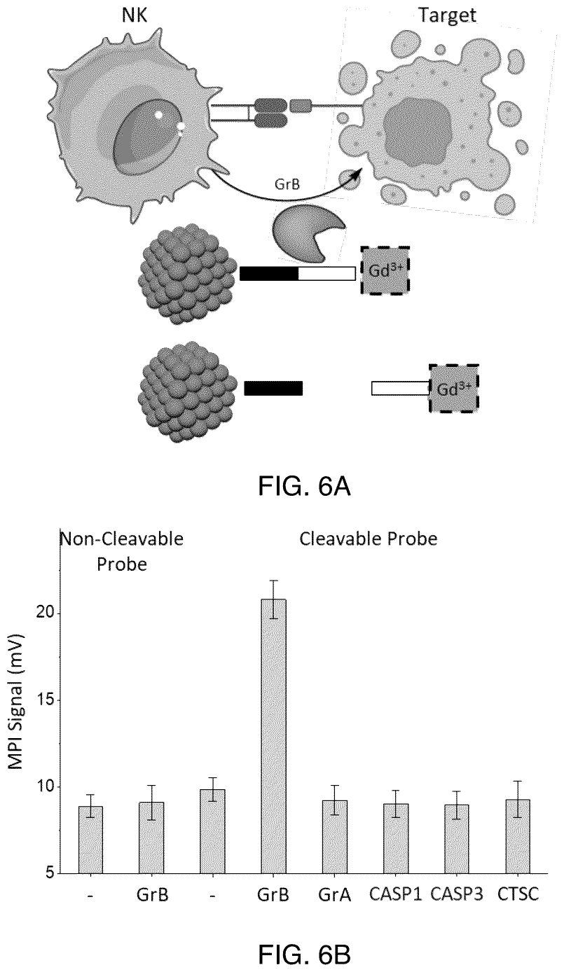

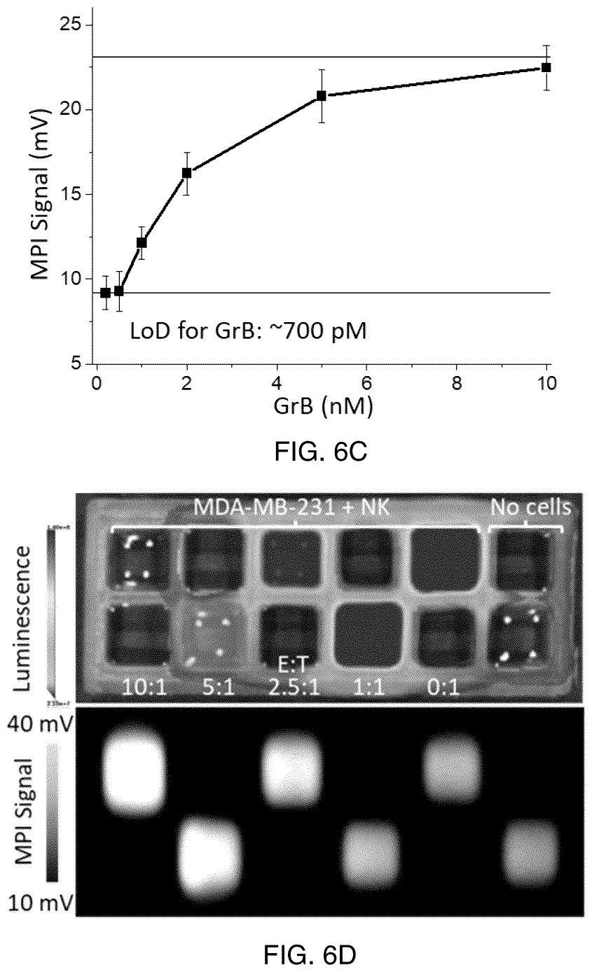

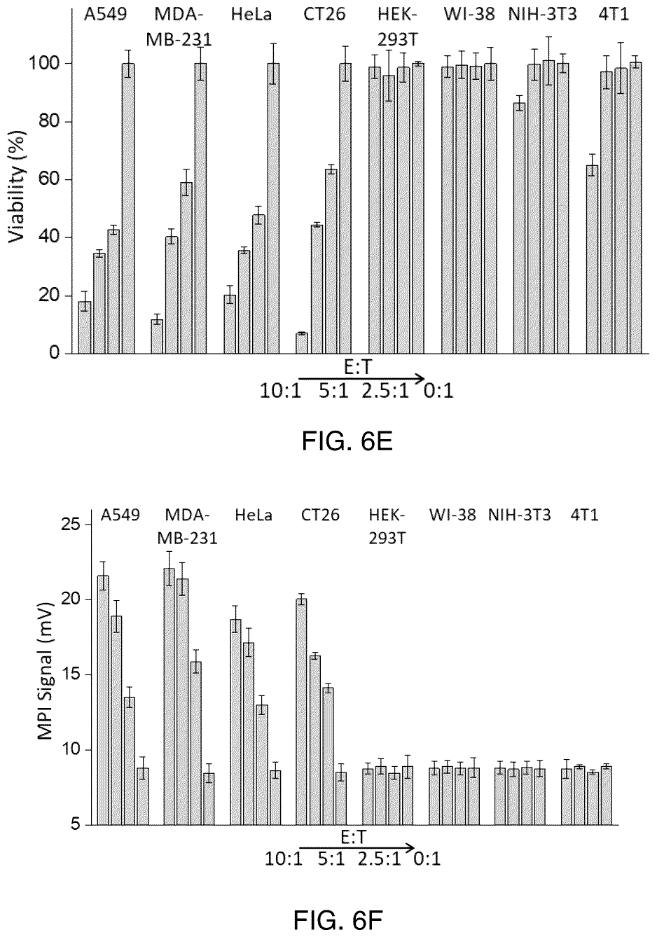

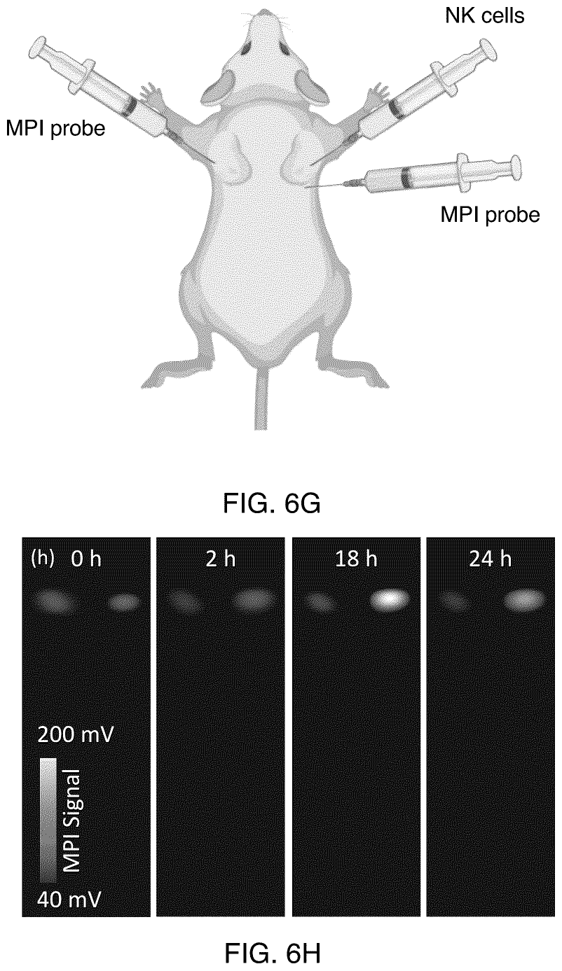

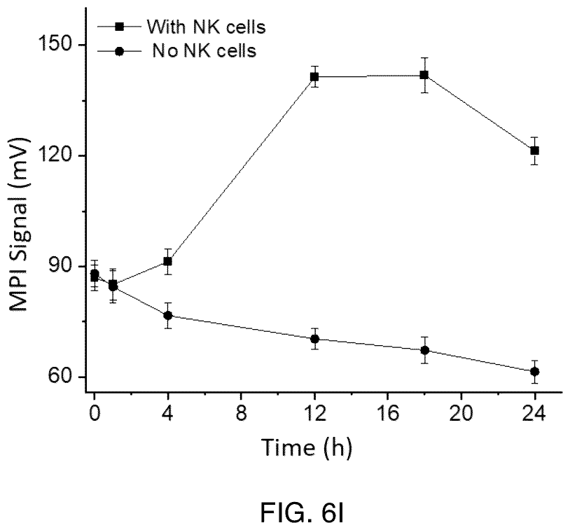

FIGS. 6A-I show MPI probe results for granzyme B (GrB) sensing. FIG. 6A is a schematic for the granzyme B-responsive MPI probe. FIG. 6B shows the selectivity of the granzyme B sensing probe. The concentration of GrB, granzyme A (GrA), Caspase 1 (CASP1), Caspase 3 (CASP3), and Cathepsin C (CTSC) was 10 nM. FIG. 6C shows MPI signals of the MPI probe (10 g/mL Fe) incubated with varying concentrations of granzyme B for 12 h. FIG. 6D shows results of monitoring the immune response in vitro. MDA-MB-231luc cells and NK cells were cocultured in the 12-well plate with different effector-to-target ratios (E:T) for 24 hours. The luminescent signals report the cancer cell viability, and the MPI signals report the granzyme B level by the MPI probe (10 μg/mL Fe). FIGS. 6E-F show the cell viability and the MPI signals of different cell lines treated with NK cells at various E:T ratios. FIGS. 6G-I show in vivo MPI imaging of GrB activity (n=3).

Peritumorally injected NK cells and intratumorally injected MPI probe (500 μg/mL Fe, 20 μL per injection) into the tumor on the right shoulder. The control tumor on the left shoulder received only the MPI probe injection.

We also expanded the MPI probes for sensing enzymatic activity, including proteases such as granzyme B. Granzyme B is an enzyme primarily released by cytotoxic T lymphocytes and natural killer (NK) cells. Detection of extracellular granzyme B in vivo provides a useful mean to non-invasively assess immune responses and monitor immunotherapy outcomes. The sensing species for this experiment was a short peptide sequence that is cleavable by granzyme B (FIG. 6A).

After the incubation of the nanoprobe solution (10 μg/mL Fe) with recombinant human granzyme B (20 nM) at 37 °C for 24 hours, the MPI signal increased by 112%, whereas no apparent signal change was observed in the control experiment with the non-cleavable probe (FIG. 6B). The conditions for granzyme B detection were optimized with an incubation time of 12 hours and the concentration of the probe at 10 μg/mL Fe. Furthermore, the incubation with other proteases, including granzyme A, yielded MPI signals comparable to the untreated control. Titration with different concentrations of granzyme B revealed a detection limit of 700 pM (FIG. 6C). Such sensitivity toward granzyme B would be helpful for immune surveillance as previous studies have reported extracellular concentrations of granzyme B in the nanomolar range in conditions where cytotoxic lymphocytes were actively engaged.

We next monitored the innate immune response of NK cells to cancer cells with the MPI probe. Human breast cancer cells (MDA-MB-231^{luc}), genetically labeled with firefly luciferase, were seeded overnight in a 12-well plate at a density of 10⁴ cells per well. Human NK cells (NK92-MI) were added to these wells at an effector-to-target (E:T) ratio of 10:1, 5:1, 2.5:1, 1:1, and 0:1. The extracellular granzyme B level was assessed by adding the MPI probe in the culture medium at 10 μg/mL Fe at the start of the co-culturing. At the end of the coculture, 10 μM of luciferin was added to each well to quantify the viability of the cancer cells. As shown in FIG. 6D, at an E:T ratio of 10:1, the near absence of luminescence indicates that NK cells have effectively eliminated the target cancer cells. At the same time, the elevated MPI signals reflects a high level of granzyme B in the medium. The negative correlation between the MPI and luminescent signals suggests the correlation of granzyme B activity and cancer cell viability. The in vitro cleavage of the MPI probe could be blocked by a granzyme B inhibitor. When the inhibitor was added to the medium, MPI signals were effectively suppressed. Despite this suppression, the low viability of the target cancer cells remained unchanged, indicating that intracellular granzyme B activity was unaffected while the MPI probe was sensing extracellular targets.

We tested more human cancer cell lines, including MDA-MB-231, A549, and Hela cells with the NK cells (FIGS. 6E-F). In the absence of the firefly luciferase reporter gene, the cell viability of the target cells was evaluated by the MTS assay. With an E:T of 10:1, their viability was generally less than 20%, and the MPI signals increased to a level close to the fully recovered state. As expected, non-cancerous cell lines HEK-293T, WI-38, and NIH-3T3 showed little decrease in viability after 24 hours of coculturing with NK cells, and the MPI signals remained quenched.

Our MPI probe was also applied to evaluate the activity of NK92 toward murine cancer cell lines. The 4T1luc cells maintained high viability even at the highest E:T ratio. Accordingly, no MPI signal activation was found. Notably, CT26, a mouse colon cancer cell line, can also be recognized by the human NK cells, where a similar pattern in the cell viability and the MPI signal to the other human cancer cells was observed, consistent with a previous study.

The in vivo immune response of adoptive NK cell transfer therapy was validated in NSG mice with the xenograft MDA-MB-231 tumor model. After the tumor reached around 200 mm³, 6*106 NK cells dispersed in 200 μL PBS were administered through peritumoral injection; meanwhile, 10 μg MPI probe dispersed in 20 μL PBS was intratumorally injected into the tumor, as illustrated in FIG. 6G. The mice were then monitored on the MPI scanner, and the results were shown in FIGS. 6H-I. At 12 to 18 hours after the injection, the highest MPI signal in the tumor site was observed, and compared to the signal right after the injection, a 62% increase was achieved. In a control experiment, where the same mass of the MPI probe was injected, the absence of the NK cells resulted in the MPI probe remaining quenched, and the signals gradually decreased over time. Using MPI signals in the control experiment as the baseline, there was about a 110% increase in the MPI signals with NK cells. The above validation in vivo demonstrated the ability of our MPI probe for imaging the activity of granzyme B from activated NK cells.

### 3) Discussion

It was revealed in the characterizations that the clusters produced an MPI signals approximately two to three times greater than that of Vivotrax®, with the highest signals observed at a mid-range cluster diameter of 35 nm. Interestingly, the 35 nm cluster and Vivotrax® share a similar hydrodynamic size (59 nm), and both contain 4 nm primary nanocrystals. However, Vivotrax® consists of nanocrystals that are merely confined within a polymer coating through cross-linking of carboxylic-dextran, so its nanocrystal interfaces do not merge. This configuration leads Vivotrax® to behave magnetically more like single-core nanoparticles, resulting in lower signals compared to the as-prepared clusters. In contrast, when primary nanocrystals share interfaces, as in the 35 nm cluster, it reduces canted spins at the surface, diminishes the magnetic anisotropies of the crystal lattice structures, and promotes exchange interactions among the nanocrystals. Consequently, the clusters exhibit higher saturation magnetizations, increased initial magnetic susceptibilities, and substantially enhanced MPI signals. From another point of view, the clustering of the primary nanocrystals does not result in a single solid nanoparticle. Previous studies have shown that single-core magnetic nanoparticles with smaller core diameters tend to relax via the Neel mechanism, while those with larger cores relax through Brownian motion, with the transition occurring at approximately 15 nm. Despite having a large physical diameter, the 35 nm cluster is still primarily governed by Néel relaxation and exhibits superparamagnetism even in the solid state. For clusters to display coercivity and remanence, their physical diameters must exceed 50 nm. Additionally, for Brownian relaxation to dominate, the diameter needs to be greater than 90 nm.

Previous studies have developed MNP-Gd nanocomplexes for dual-mode T1 and T2 magnetic resonance imaging using small iron oxide nanoparticles (6 to 17 nm) as the magnetic core. The influence of gadolinium chelates on the core's magnetic properties varies based on core size and surface coatings. For example, in one study involving 6 nm monodisperse Fe₃O₄ nanoparticles, direct conjugation of DOTA-Gd on the surface enhanced the nanoparticle's saturation magnetization (normalized by iron mass). In contrast, introducing a PEG linker between the MNP and DOTA-Gd significantly reduced saturation magnetization.

This finding highlights the impact of coating agents in creating a “magnetic silent” outer layer, where paramagnetic chelators and ligand anchoring groups can disrupt crystallinity and affect spin canting.

Consistently, phosphate-based ligands with short-range Gd inclusion exhibited reduced spin canting. In another study using 12 nm Fe₃O₄ nanoparticles, the addition of bisphosphonate ligand or DOTA-Gd to the surface also increased saturation magnetization. However, when the core size increased to 17 nm, gadolinium labeling reduced both saturation magnetization and the r2 value. Attaching Gd to the surface can produce diverse magnetic outcomes, underscoring the importance of nanoparticle size and surface chemistry in MNP-Gd systems.

In our cluster-Gd nanocomplex, we hypothesize that the paramagnetic gadolinium layer interacts with the canted spins on the surfaces of magnetic clusters. This interaction may increase the proportion of randomly aligned surface spins relative to the core, thereby reducing the clusters' overall magnetic response to external fields and affecting their Neel relaxation. For the 35 nm cluster, which is dominated by Néel relaxation, it can be effectively quenched in media even with high viscosities that significantly affect Brownian relaxation.

Additionally, Gd appears to have a less significant effect on the MPI signals of Vivotrax® and Ferumoxytol, whose core diameter is less than 6 nm. This is likely due to their small single-core structures, which exhibit extensive spin canting. In contrast, the partially merged surfaces of the 35 nm cluster reduce spin canting. As a result, conjugating Gd substantially increases the random surface spins in the 35 nm cluster more than in these single-core materials, leading to notable MPI quenching.

Further optimizing the clusters' magnetic properties and surface modifications, such as forming ferrite clusters with enhanced saturation magnetization and lower magnetic anisotropy, can increase MPI signals in the “turn-on” state; meanwhile, incorporating a higher density of Gd, such as the multinuclear chelator, may boost quenching efficiency and reduce background signals in the “turn-off” state, offering valuable insights for designing versatile MPI probes that target a wider range of biological applications.

### 4) Conclusions

In summary, this work presents a novel, activatable nanoprobe designed for magnetic particle imaging, addressing the need for molecular-level tracers. The core of the probe comprises the iron oxide nanocrystal clusters, producing over twice the MPI signals of Vivotrax® (the current gold standard). When the paramagnetic Gd chelate quencher is attached, the MPI signal is reduced by 62%, but signal strength returns to its original level once the quencher is removed. The nanoprobe's signal can be selectively restored by employing bio-cleavable linkers responsive to cell signaling molecules (NO), reducing agents (GSH), and proteases (Granzyme B). This reversible quenching strategy holds promise for sensitive, targeted molecular diagnostics and various image-guided biomedical applications.

1. A method of providing chemically selective magnetic particle imaging, the method comprising:
forming nanocrystal clusters by fusing superparamagnetic iron oxide nanocrystals;
binding a paramagnetic quencher to surfaces of the nanocrystal clusters with a sensing species to provide quenched magnetic nanoparticles;
wherein the sensing species includes at least one bond that is cleavable by a target chemical species;
performing magnetic particle imaging on a subject using the quenched magnetic nanoparticles;
wherein the magnetic particle imaging is sensitive to concentration of the target chemical species in the subject.

2. The method of claim 1, wherein the nanocrystal clusters have diameters in a range from 20 nm to 60 nm.

3. The method of claim 1, wherein the nanocrystals have diameters in a range from 2 nm to 6 nm.

4. The method of claim 1, wherein a magnetic response of the nanocrystal clusters is dominated by Neel relaxation.

5. The method of claim 1, wherein the paramagnetic quencher includes one or more species selected from the group consisting of: Gd, Ho, Mn, Eu and ions thereof.

6. The method of claim 1, wherein the paramagnetic quencher is configured as a polymer or nanoparticle containing a paramagnetic species.

7. The method of claim 1, wherein the fusing superparamagnetic iron oxide nanocrystals comprises hydrothermal synthesis.

8. The method of claim 1, wherein the superparamagnetic iron oxide nanocrystals are doped with one or more species selected from the group consisting of: Mn, Co, Zn, Ni and ions thereof.
